(19) United States
(12) Patent Application Publication
(10) Pub. No.: US 2011/0313884 A1
(43) Pub. Date: Dec. 22, 2011

(54) ONLINE LOAN APPLICATION SYSTEM USING BORROWER PROFILE INFORMATION THROUGH A BACKGROUND SEARCH PROCESS

(76) Inventor: Ike O. Eze, Oakland, CA (US)

(21) Appl. No.: 13/163,214

(22) Filed: Jun. 17, 2011

Related U.S. Application Data
(63) Continuation-in-part of application No. 12/575,436, filed on Oct. 7, 2009, now abandoned.
Application No. 12/575,436 is a continuation of application No. 11/787,485, filed on Apr. 16, 2007, now Pat. No. 7,620,597.
(60) Provisional application No. 60/792,079, filed on Apr. 14, 2006.

(51) Int. Cl. G06Q 30/00; G06Q 40/00

(52) U.S. Cl. 705/26.41

(57) ABSTRACT

Embodiments of an online credit application system are described. The online credit application system displays a solicitation page requesting user credit score information and a selection of desired loan products. Embodiments include means for receiving a request by the user to purchase an item through an online application form, the request including identification information of the user; means for determining whether financing is available for at least part of the purchase request; means for transmitting the identification information to a second server, wherein the second server is configured to obtain a measure of the user's qualification to obtain the financing through a below-the-line credit check from a credit bureau; means for receiving from the second server the measure of the user's qualification and comparing it to the requirements of the financing; and means for notifying the user that the financing is available if the measure of the user's qualification satisfies the requirements of the financing.

### CROSS-REFERENCE TO RELATED APPLICATIONS

The present application is a Continuation-In-Part application of U.S. application Ser. No. 12/575,436 entitled “Online Loan Application System Using Borrower Profile Information,” filed on Oct. 7, 2009, which is a continuation of 11/787,495 filed Apr. 16, 2007 now U.S. Pat. No. 7,620,597 issued Nov. 17, 2009, which claims the benefit of the U.S. Provisional Application No. 60/792,079 filed on Apr. 14, 2006.

### FIELD

Embodiments of the invention relate generally to electronic commerce systems, and more specifically, to online loan and credit application systems.

### BACKGROUND

A multitude of different loan products and credit cards are available to borrowers. A person's ability to obtain loans or credit cards at favorable rates and terms, however, depends on that person's credit score, as well as other possible criteria. Generally a credit score reflects a person's creditworthiness and is expressed as a number that represents a risk level to a lender. The higher the credit score, the more creditworthy a person is. A high credit score generally allows a person to borrow money at better rates and under better terms. Financial institutions typically offer many different loan or credit products depending upon the financial profile of the borrowers. Under present loan application systems, a borrower must typically shop for a loan by making inquiries to the different financial institutions or shop through loan brokers. Such a process is typically very time consuming and often does not give the borrower a complete picture of what is available. With the advent of web-based processes, online systems for shopping for loans have become available. These systems however, may only provide only a general selection of loan products that are available and not an accurate selection of products based on the qualifications of the borrower. Moreover, such systems may require that the lender or broker pull the borrowers credit report. If a person uses such a system to shop among a variety of different products, this can adversely affect the person's credit rating since multiple credit report pulls can lower the person's credit rating.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a computer network system that implements embodiments of an online credit application system;

FIG. 2 is a flowchart that illustrates a method finding and displaying loan products for a user, according to an embodiment;

FIG. 3 is a flowchart that illustrates a method of matching available loan products to credit score information for a user, according to an embodiment;

FIG. 4 is a flowchart that illustrates a method of matching available loan products to credit information for a user, according to an alternative embodiment;

FIG. 5 illustrates an example of a web page for finding loans or credit offers, according to an embodiment;

FIGS. 6A and 6B illustrate an example of a web page listing possible loans for a credit score of 700, according to an embodiment;

FIG. 7 illustrates an example of a qualification web page for a loan product listed in FIG. 6A, according to an embodiment;

FIG. 8 illustrates an example of an application web page for the loan product illustrated in FIG. 7;

FIGS. 9A and 9B illustrate an example of a web page for the vendor of a loan product, under an embodiment;

FIG. 10 illustrates an example of a web page listing possible loans for a credit score of 550, according to an embodiment;

FIG. 11 is a flowchart that illustrates a method finding and displaying loan products for a user, according to an alternative embodiment in which indirect credit information is used to access available loan products;

FIG. 12 illustrates an example of a web page for applying for and selecting loan products, according to an alternative embodiment;

FIG. 13 illustrates an example of a qualification web page for a loan product listed in FIG. 12, according to an embodiment;

FIG. 14 illustrates an example of an application web page for the loan product illustrated in FIG. 13; and

FIG. 15 illustrates an example of a confirmation page for the loan product illustrated in FIG. 14.

FIG. 16 is a flowchart that illustrates a method of notifying a user of available financing options as a background task through an online form server, under an embodiment.

### DETAILED DESCRIPTION

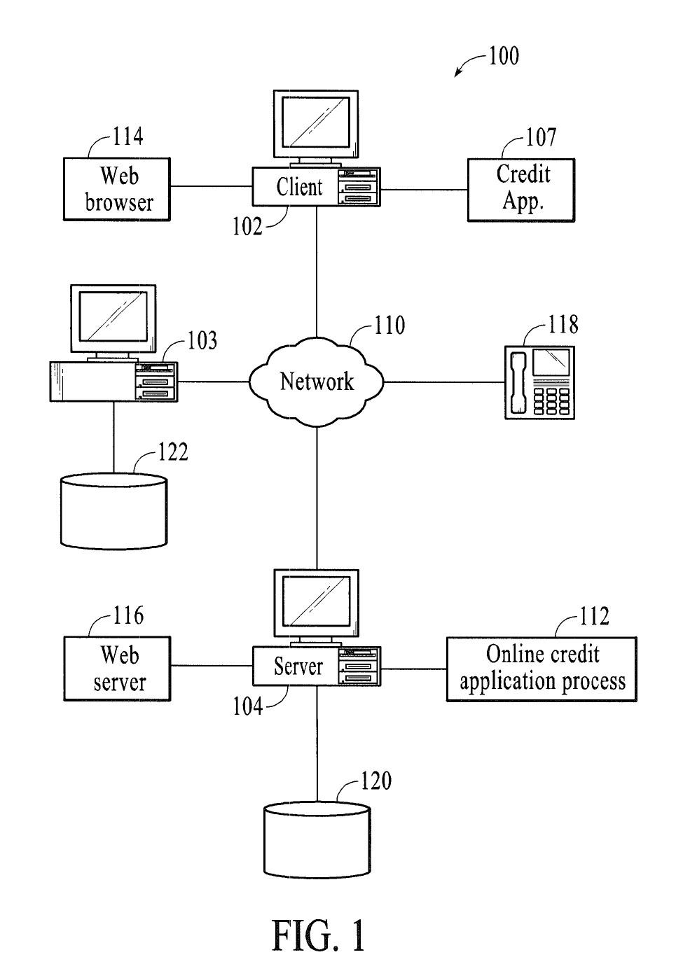

Embodiments of an online credit application system are described. Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server side online credit application process 112. Client versions of this process 107 may also be executed on the client computers. This process may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the online credit application process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP). Data for any of the loan products, credit card products, debt products, user information, and the like may be provided by a data store 120 closely or loosely coupled to any of the server 104 and/or client 102. In one embodiment, the client computer may execute a client side credit application program 107 to interact with the server-side online credit application process 112. A separate content provider 103 may provide some of the data that is included in the product offering or application process.

The client computer 102 may be a workstation computer or it may be a computing device such as a notebook computer, personal digital assistant, or the like. The client computer may also be embodied within a mobile communication device 118, game console, media playback unit, or similar computing device that provides access to the Internet network 110 and a sufficient degree of user input and processing capability to execute or access the client-side credit application program 107. The client computers 102 and 118 may be coupled to the server computer 104 over a wired connection, a wireless connection or any combination thereof.

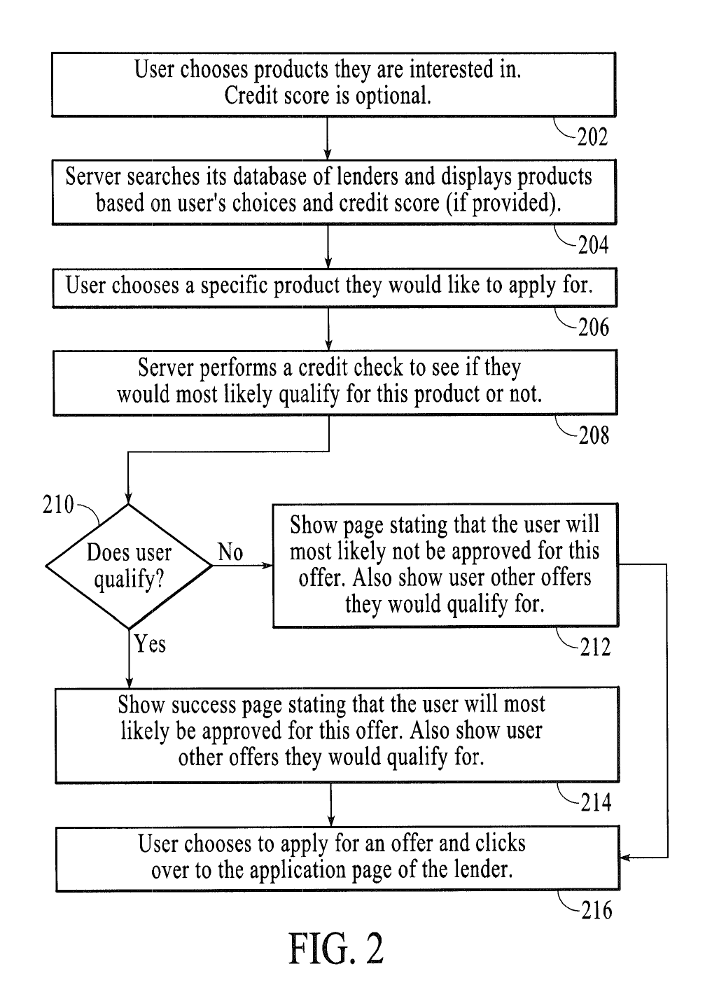

In one embodiment an online credit application system 112 facilitates the loan selection and application process through the display of loan application interfaces to a user. FIG. 2 is a flowchart that illustrates a method of finding and displaying loan products for a user, according to an embodiment. For the embodiment of FIG. 2, a loan application form is displayed on the client computer. In block 202, the user chooses the loan product that he or she is interested in. At this stage the user may provide his credit score, if it is known. The online credit application process 112 on server 104 searches its databases of lenders and displays products available on the user's choice and eligibility based on the credit score, if it was provided, block 202. The user then selects a specific loan product to apply for, block 206. In block 208 the server performs a credit check to verify whether or not the user qualifies for the selected loan product. If in block 210 it is determined that the user does qualify for the selected loan product, the server displays a success page stating that the user will most likely be approved for the loan offer. The server may also display other loan products that the user would qualify for, block 212. In block 216, the user applies for the loan and then accesses the application of the lender. If, in step 210 it is determined that the user does not qualify for the selected loan product, the server displays a page indicating that the user would probably not be approved for the selected offer. It then displays other loan products that the user might be approved for.

In one embodiment, the server computer 104 has access to a wide variety of different loan products available from any number of commercial or private lenders or financial institutions. Typically these products are accessed through a variety of networks and stored in databases maintained by these lenders. Alternatively, these products may be consolidated and stored in a single (or virtually single) database that is accessible to the server, such as on a data store 120 or data store 122 maintained by a separate server 103.

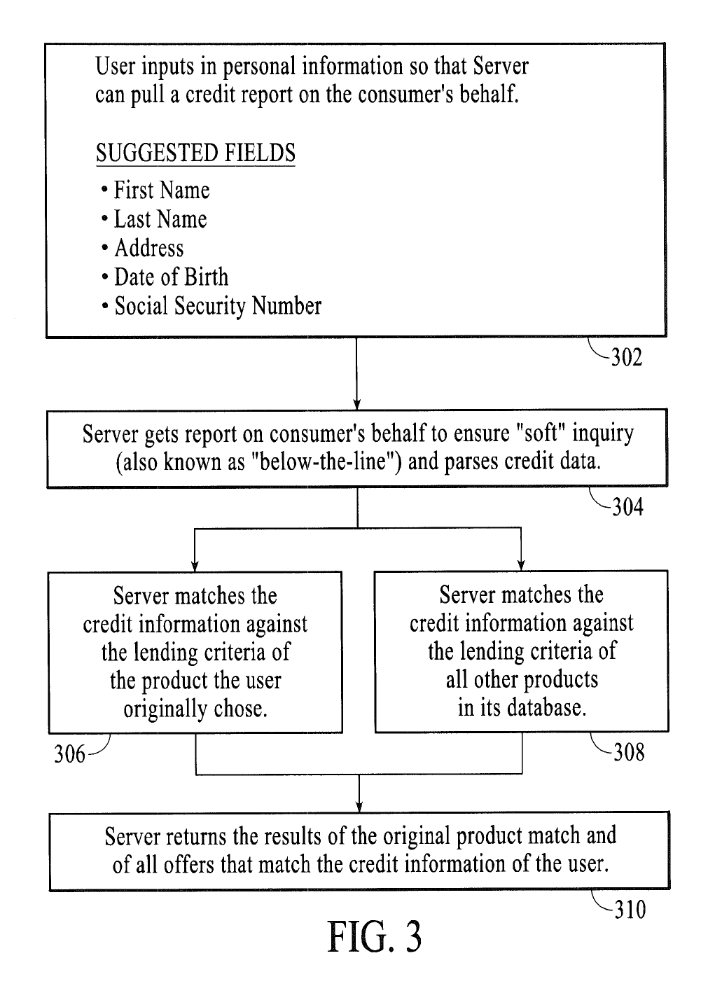

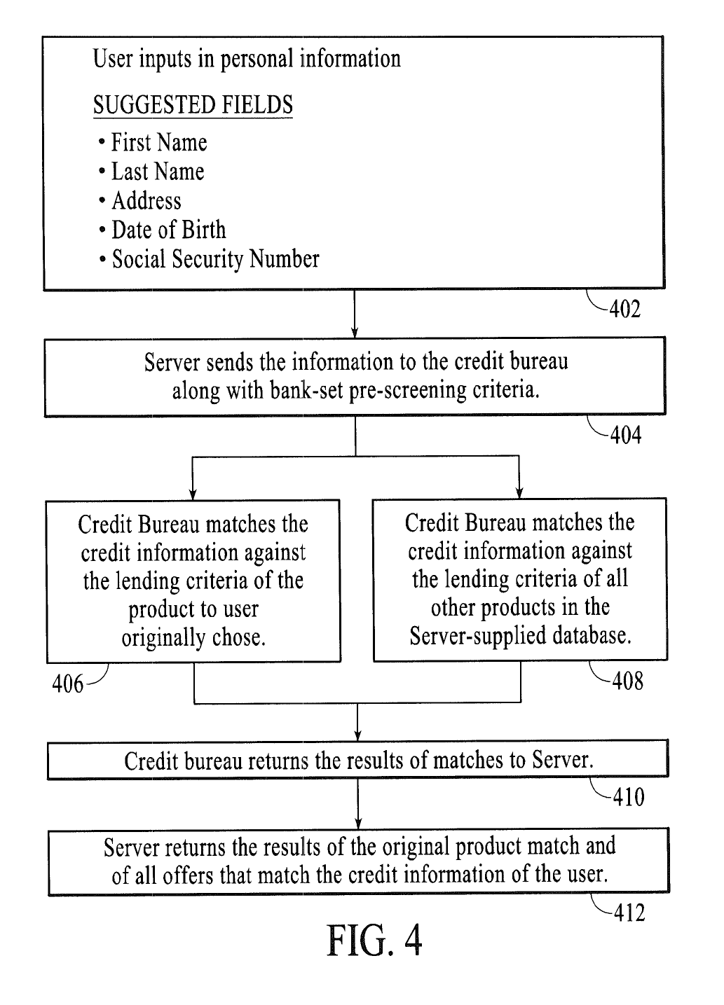

For the embodiment of FIG. 2, a credit score is provided to the server so that the appropriate loan products can be displayed for selection by the user based on eligibility of the user. This credit score information can be provided to the system directly by the user, or alternatively it can be obtained by the server, from a third party service, based on information provided by the user. This is illustrated as step 208 in FIG. 2, and at least two different credit pull process flows are possible, as illustrated in FIGS. 3 and 4.

FIG. 3 is a flowchart that illustrates a method of matching available loan products to credit score information for a user, according to an embodiment. In block 302 the user inputs certain items of personal information, such as name, address, date of birth and any other uniquely identifying items of information. The user's social security number may or may not be required depending upon the requirements of the service that provides the credit score. In block 304, the server receives the user's consumer report on the user's behalf. This is done in a manner that attempts to ensure that the user's credit score is not impacted. In general, the more frequent a user's credit score is accessed, the greater the likelihood that the credit score will be reduced. This is due to certain access practices imposed by services that provide credit score and credit reporting information. A so-called “soft” or “below-the-line” inquiry constitutes a credit report pull that does not negatively impact the user's credit score. Once the credit report is obtained, the relevant credit data and score is parsed out.

Once the server has the user's credit score, or other pertinent credit information, it matches this information against the lending criteria for the loan product that the user originally selected, block 306. It also matches this information against the lending criteria for other products in the database, block 308. The server then returns the results of the original product match and all other offers that might match the credit score or information of the user, block 310.

For the embodiment of FIG. 3, a soft inquiry was performed by the server on the user's behalf. In certain circumstances, such a soft inquiry is not possible or practical, and a credit bureau or similar organization must be used to obtain the credit report information. FIG. 4 is a flowchart that illustrates a method of matching available loan products to credit information for a user, according to an alternative embodiment in which a credit bureau is used. In block 402 the user inputs certain items of personal information, such as name, address, date of birth and any other uniquely identifying items of information. The user's social security number may or may not be required depending upon the requirements of the credit bureau that provides the credit score. In block 404, the server transmits the user information to a credit bureau along with a defined set of pre-screening criteria. This pre-screening criterion typically comprises criteria defined by a bank or financial institution. Once the credit report is obtained, the credit bureau matches this information against the lending criteria for the loan product that the user originally selected, block 406. It also matches this information against the lending criteria for other products in the database, block 408. The credit bureau then returns the results of the matches to the server, block 410. In block 412, the server returns the results of the original product match and all other offers that might match the credit score or information of the user.

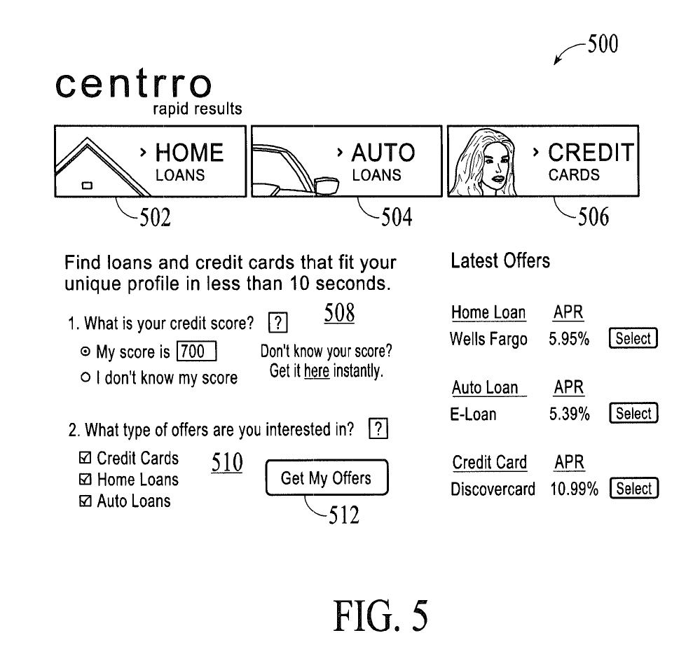

In one embodiment, the network 110 is the Internet, and server 104 executes a web server process 116 to allow users to access the online credit application process 112 through a web based interface through client-side web browsers 114. As shown in block 202 of FIG. 2, the user starts the loan application process by selecting the loan product or products that he is interested in. This selection is usually done through a web page displayed through the web browser of the user's client computer. FIG. 5 illustrates an example of a web page for finding loans or credit offers, according to an embodiment. Web page 500 represents the initial web page that is displayed by the online credit application process 112. It provides an access point for all of the loan products available through server 104. For the embodiment of FIG. 5, the loan products are organized by loan type, thus the user is able to apply for a home loan 502, a car loan 504, or a credit card 506. Many other loan products or even sub-categories of loan types (e.g., first mortgages, re-finances, etc.) may also be provided. The user is prompted to input their credit score in display area 508 of the web page 500. If the user does not know his or her score, the server provides a mechanism in which it can access the score or utilize a credit bureau to obtain the score, as described with reference to FIGS. 3 and 4. The user may specify which type or types of loan products to be applied for in display area 510. Once all of the relevant information is provided, the user proceeds with the online loan application process by selecting button 512.

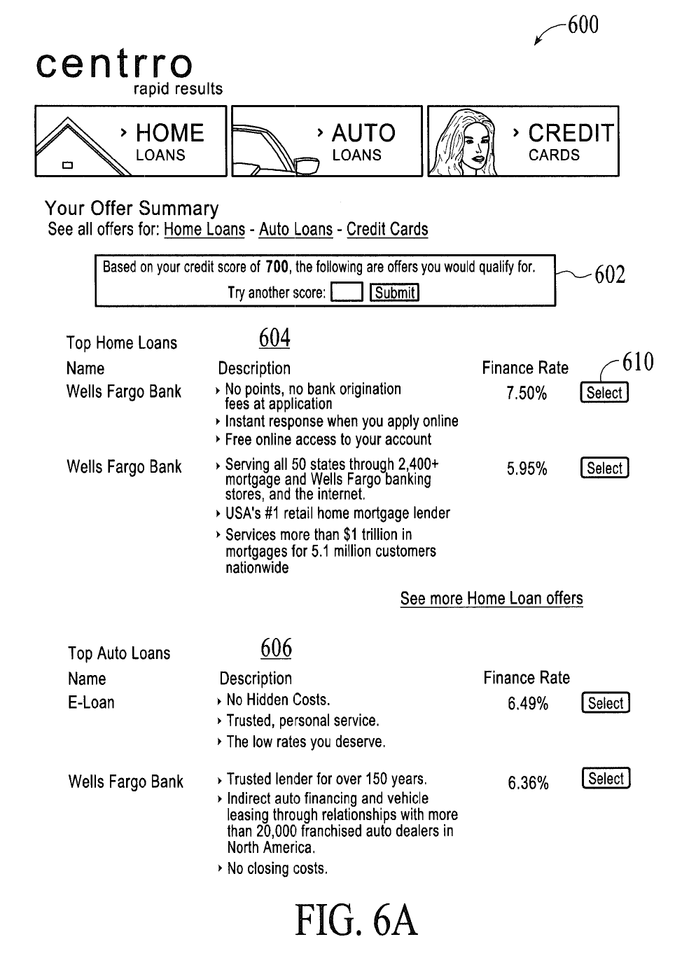

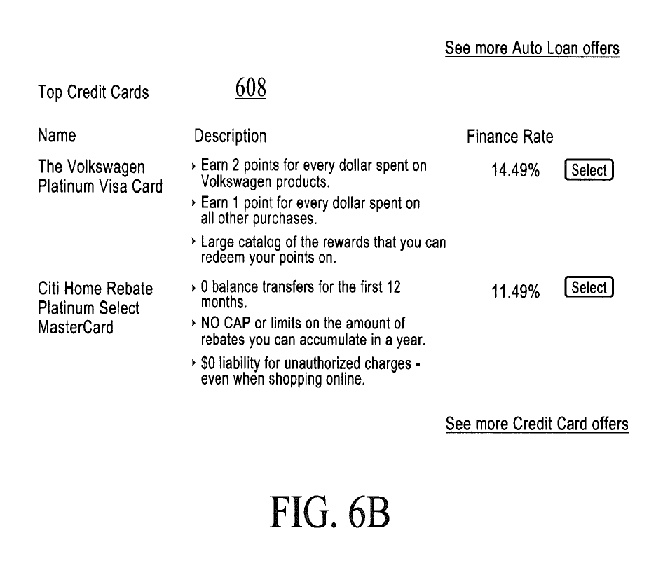

Once the user provides the relevant information and loan product selection, the server searches its database and displays the possible products, as shown in block 204 of FIG. 2. This is provided to the user in the form of a responsive web page. FIGS. 6A and 6B illustrate an example of a web page listing possible loans for a credit score of 700, according to an embodiment. Web page 600 contains several display fields that outline the possible loan products based on the user's input credit score, or the credit score obtained on the user's behalf. In section 602, the user can enter a different credit score, in cases where the user made a mistake or the user is interested in seeing what type of loan products are available for different credit scores. For the example entry of FIGS. 5, the user selected three types of loan products. Thus, in web page 600, a selection of home loans is shown in display area 604, a selection of auto loans is displayed in display area 606, and a selection of credit cards is displayed in display area 608. If several loan products are available, only the top loans per type may be displayed at any one time. Alternatively, depending upon the constraints of the display system, all possible products may be displayed on the web page. Each possible loan product can be selected using a corresponding selection button, 610.

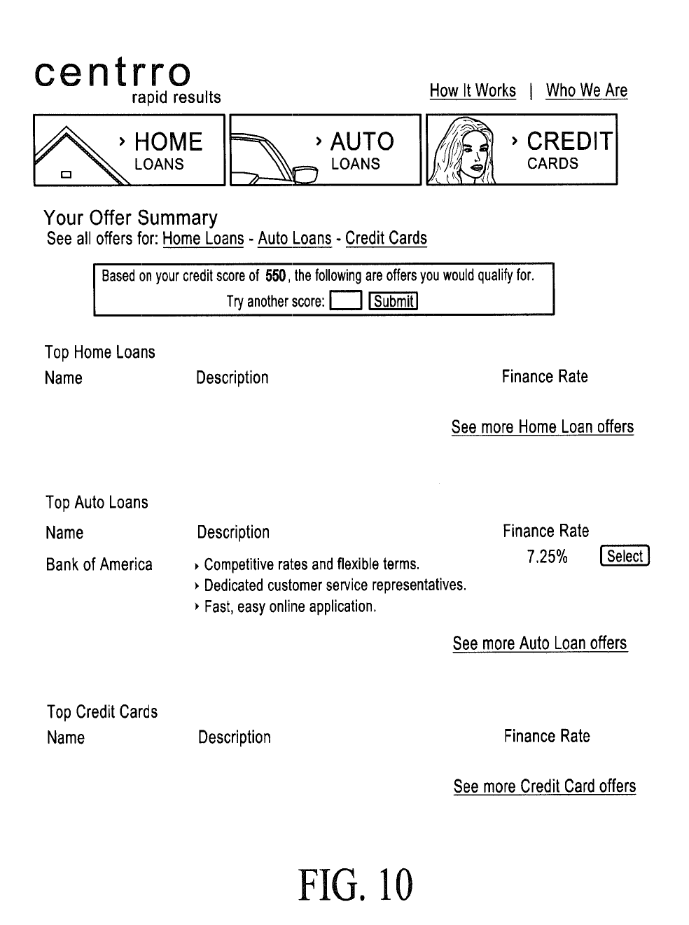

Depending upon a user's credit score, the number of loan products may vary. In general, fewer loan products are available to users with lower credit scores, and such loan products tend to be more expensive (in terms of interest rate or fees) or restrictive. FIG. 5 illustrates an example of loan product offerings for a person with a credit score of 700, while FIG. 10 illustrates an example of an example of possible loan products for a person with a credit score of 550. As can be seen in FIG. 10, only a small number of loans are available and at a higher interest rate than the products offered to persons with a credit score of 700.

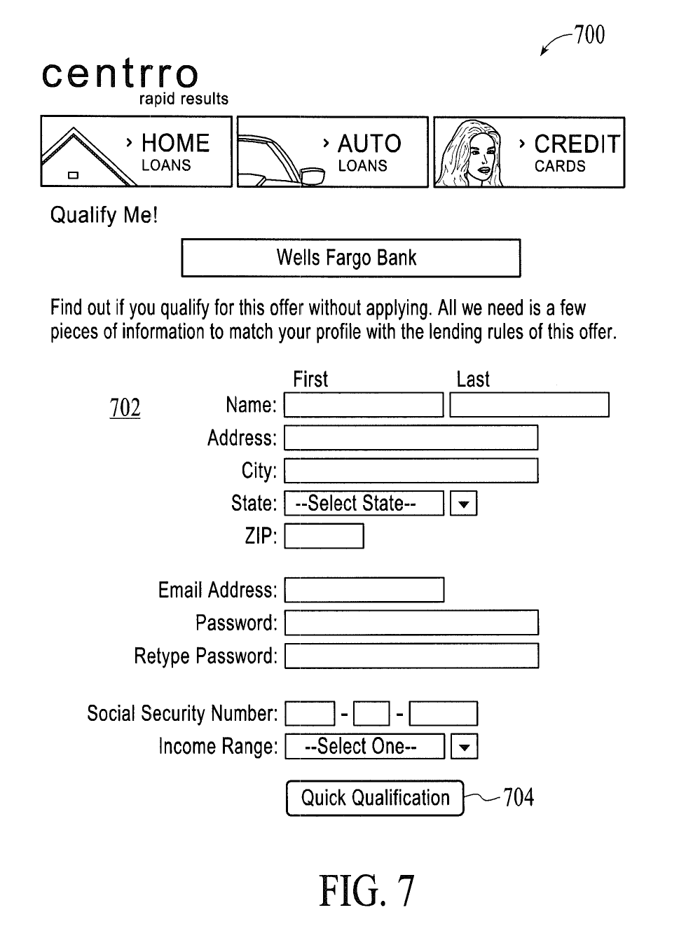

When the selection button for a particular loan product is selected, the server causes a qualification page to be displayed, which allows the user to find out whether or not they actually qualify for the loan product that they have selected. FIG. 7 illustrates an example of a qualification web page for a loan product listed in FIG. 6A, according to an embodiment. The qualification page 700 provides a means for a user to verify qualification without actually applying for the product. Display area 702 provides data entry windows for the user to enter relevant personal information related to the application and qualification for the loan product. These include identifying information, such as name, address, social security number, and so on, as well as financial information, such as annual income, and so on. Once the pertinent information has been entered, the user can select the qualification button 704 to receive the results of the qualification test.

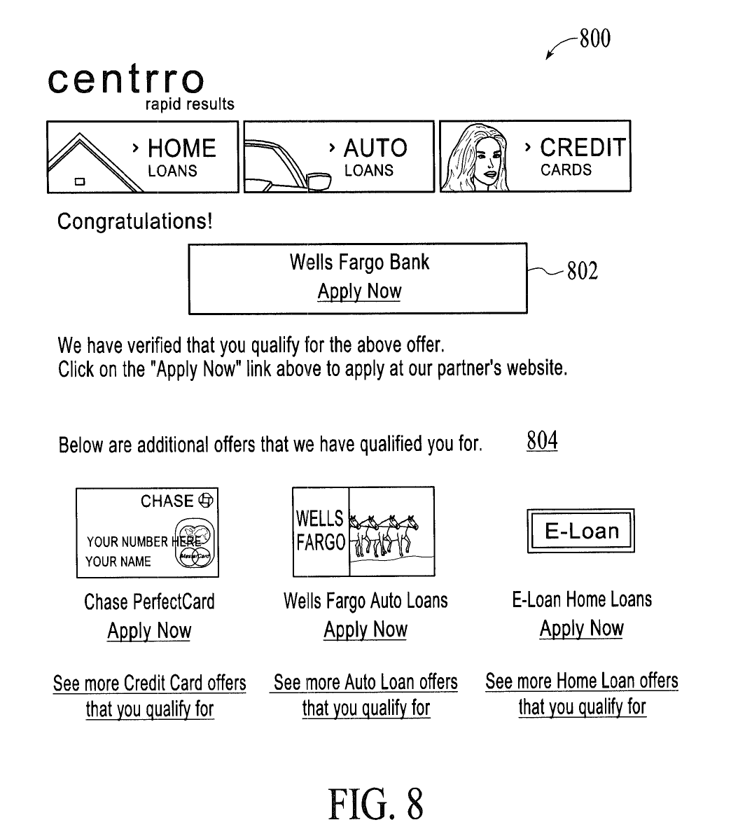

As shown in the process flow of FIG. 2, if the user is not qualified for the selected loan product, a list of loan products that the user may be qualified for is displayed. If the user is qualified for the selected loan product, a loan application page is displayed. FIG. 8 illustrates an example of an application web page for the loan product illustrated in FIG. 7. As shown on web page 800, the success page includes an application command button 802 that allows the user to apply for the selected loan. This transports the user to the lender's website, where the user can then go through the actual loan application process. The success page 800 may also include a list of other loan products that the user is qualified to apply for, such as shown in display area 804.

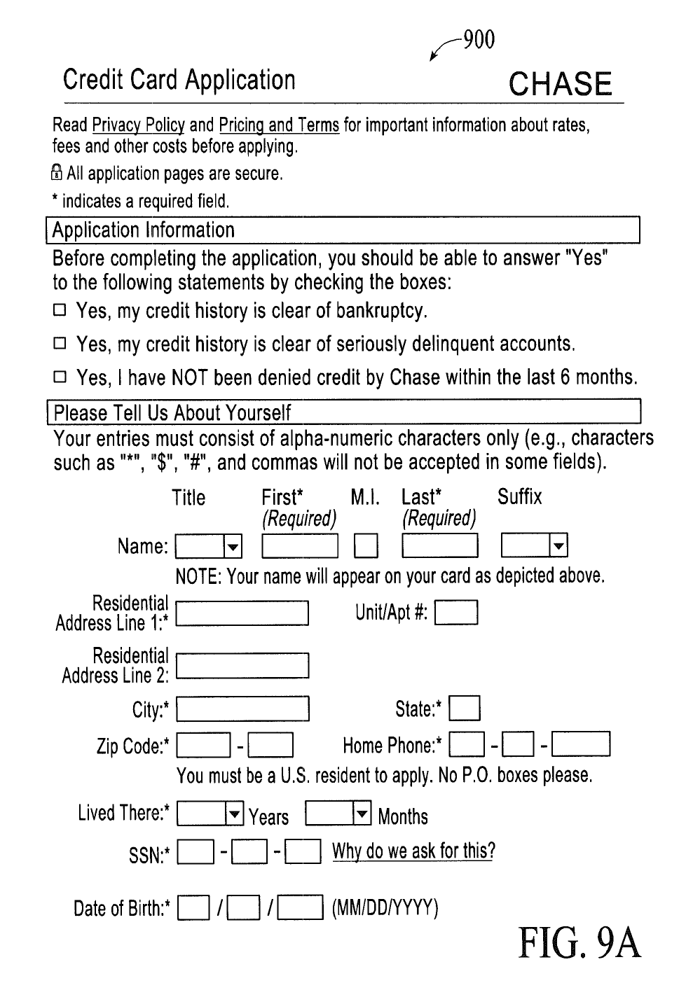

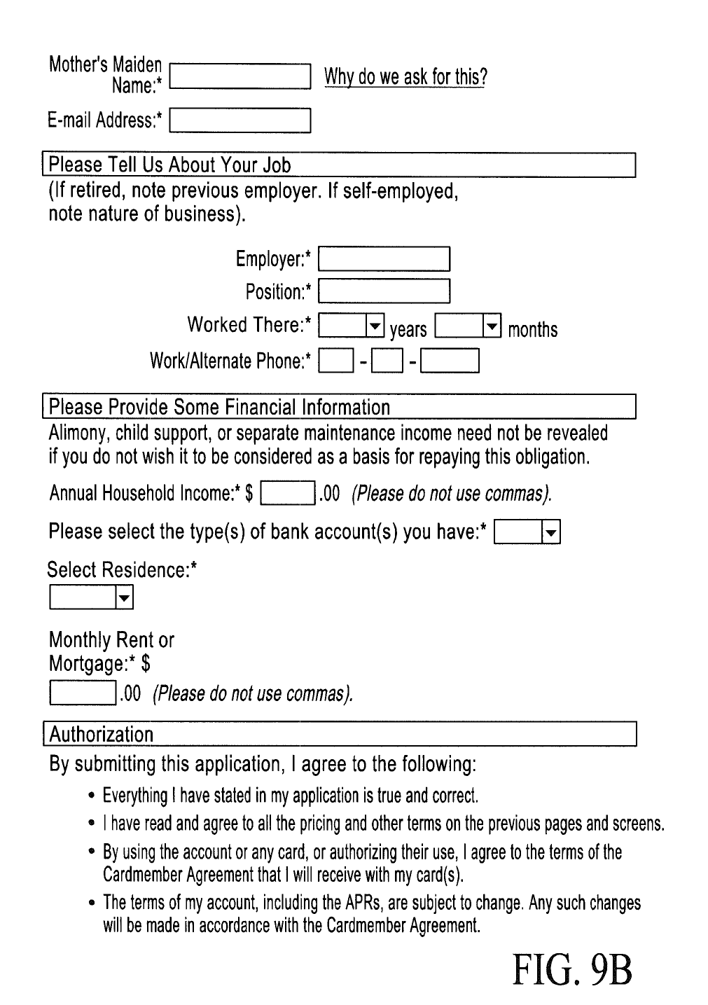

In one embodiment, the online credit application process 112 can provide access to lenders websites directly to allow users to select loan products through the lender sites. FIGS. 9A and 9B illustrate an example of a web page for the vendor of a loan product, under an embodiment. Web page 900 illustrates a typical loan application page for a vendor, and shows data entry areas for the relevant user information and loan product information required by the vendor. The web page of FIGS. 9A and 9B are intended to illustrative and many different formats are possible depending upon the vendor.

For the process flow illustrated in FIG. 2, the online loan application process was initiated by the server receiving from the user, or obtaining from a credit bureau, actual credit score information for the user. In most cases, such an inquiry could constitute a credit pull that might affect the user's credit score. Such a process could also be relatively expensive, as credit bureaus and credit reporting services may charge a not insignificant amount of money per credit pull. In an alternative online credit application process, the user does not provide an actual credit score, but rather a qualitative measure or range of his or her credit worthiness.

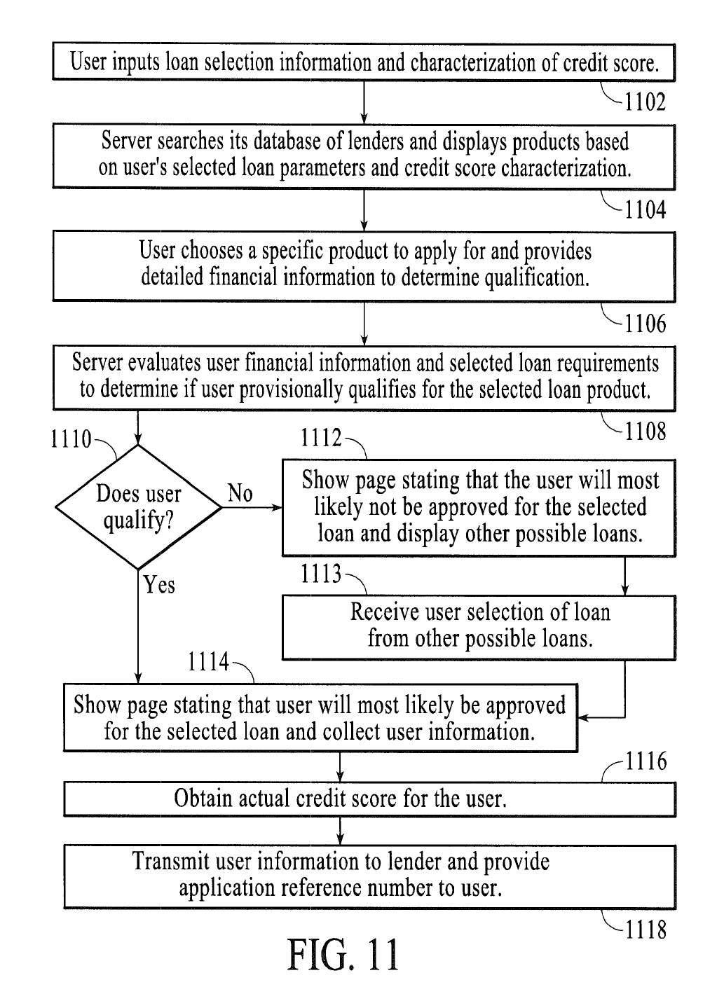

FIG. 11 is a flowchart that illustrates a method of finding and displaying loan products for a user, according to this alternative embodiment. For the embodiment of FIG. 11, an alternative type of loan application form is displayed on the client computer. This loan application form solicits information from the user regarding loan parameters, such as type and amount of loan desired. In block 1102, the user inputs loan selection information that indicates the type, purpose and amount of loan desired. The user also provides a qualitative measure or characterization of his or her credit score. Such a characterization could be a selection from the range POOR-FAIR-GOOD-EXCELLENT; it could be a letter grade, e.g., A-F, or a numeric value, e.g., 1-10, and so on. The online credit application process 112 on server 104 searches its databases of lenders and displays products available on the user's choice and eligibility based on the type of loan and user's credit score characterization, block 1102. The user then selects a specific loan product to apply for, and at this point provides detailed financial information about the user, block 1106.

In block 1108 the server evaluates the financial information and the selected loan requirements to determine if the user provisionally qualifies for the selected loan. If, in block 1110 it is determined that the user does not qualify for the selected loan product, a page stating probable non-approval with a selection of other possible loans is then displayed, as shown in block 1112. The user may choose to apply for another loan within this new selection of loans. If the user does select such a loan, the system receives the user selection of loans from the list of other possible loans, block 1113, and the process proceeds with block 1114.

If, in block 1110 it is determined that the user does likely qualify for the selected loan product, the server displays a success page stating that the user will most likely be approved for the loan offer, block 1114. This page also provides input areas for the user to provide detailed user information so that relevant credit information can be obtained, and the system collects the user provided information. This user information includes relevant identifying information, such as user name, address, date of birth, and social security number. In block 1116, the server uses the user identification information, including the social security number (if provided by the user) to obtain the actual credit score for the user. If the social security number is not provided, then the other identifying information is used. The server then transmits all of the relevant user and selected loan product information to the appropriate lender, and transmits an application reference number back to the user, block 1118.

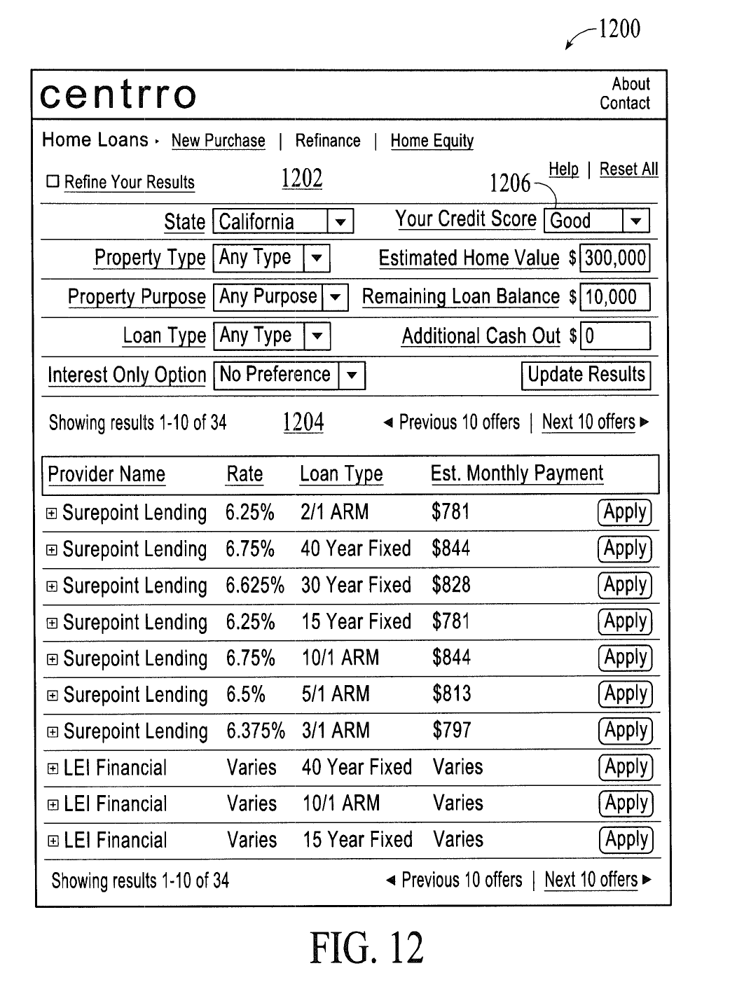

FIG. 12 illustrates an example of a web page for applying for and selecting loan products, according to an embodiment shown in the flow process of FIG. 11. As shown in block 1102, the user inputs loan selection information that indicates the type, purpose and amount of loan desired. Web page 1200 includes a number of data input fields 1202 for an example home loan. In this case, the user specifies the location, the type and purpose of the property. The user also inputs certain information regarding the cost of the property. In data input field 1206 the user provides a characterization of his or her credit score. The data entry field 1206 includes a pull-down menu that allows the user to choose one of a number of selections, such as poor, fair, good, or excellent. Each of these selections corresponds to a range of numbers within the total credit score range of 300 to 850. Using the characterization of the credit score, the online credit application process 112 is able to find and display a number of possible loan products based on the user information. A selection of possible loan products is displayed in display area 1204.

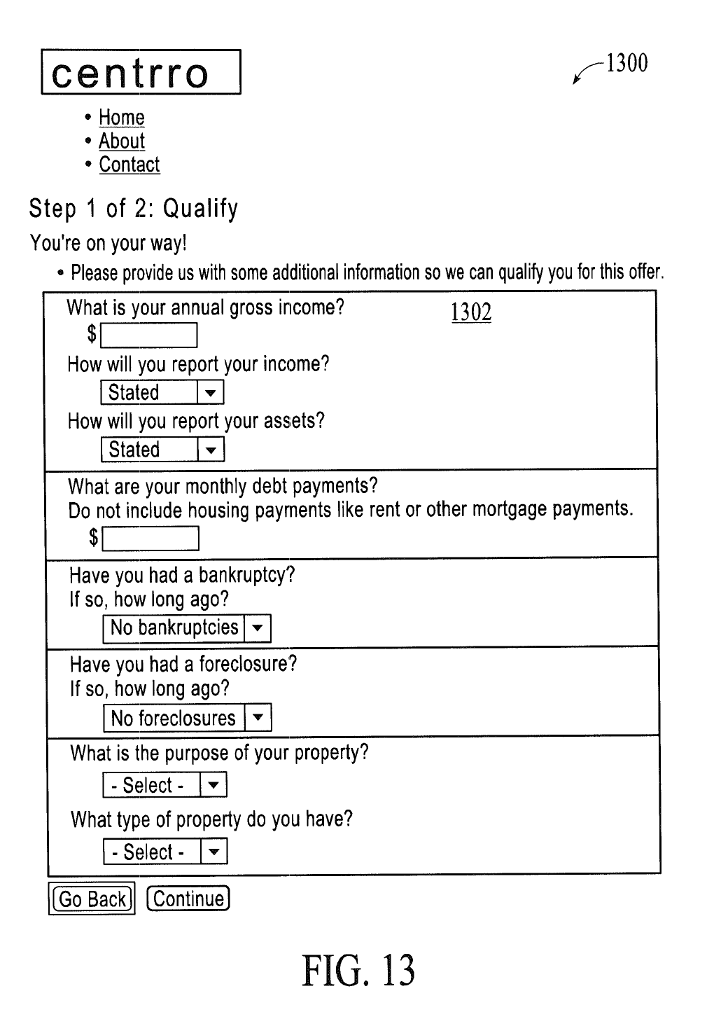

As shown in FIG. 12, each displayed loan product has a command button that allows the user to apply for a particular selected loan product. Once a loan is selected the process causes a loan qualification page to be displayed. FIG. 13 illustrates an example of a qualification web page for a loan product listed in FIG. 12, according to an embodiment. In display area 1302, the user provides certain detailed financial information. This financial information can include income and debt information, past payment and credit information, as well as any relevant information regarding the property (in the case of a real estate loan) and the desired loan. Once the user provides the required financial information, the process evaluates the user information and the loan requirements to determine the qualification of the user, as shown in block 1108 of FIG. 11.

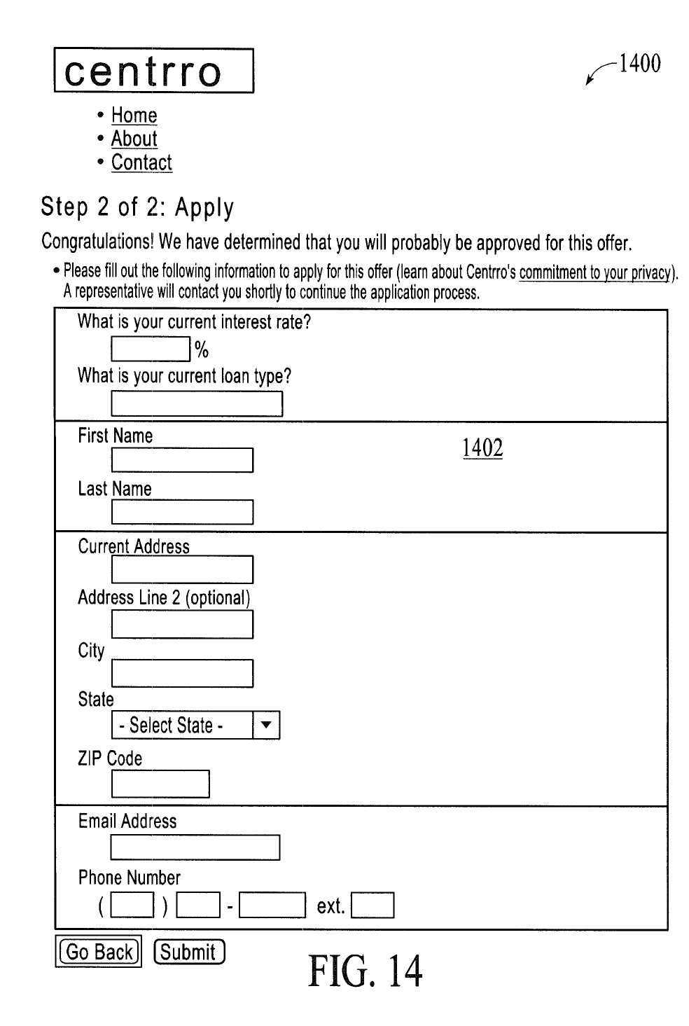

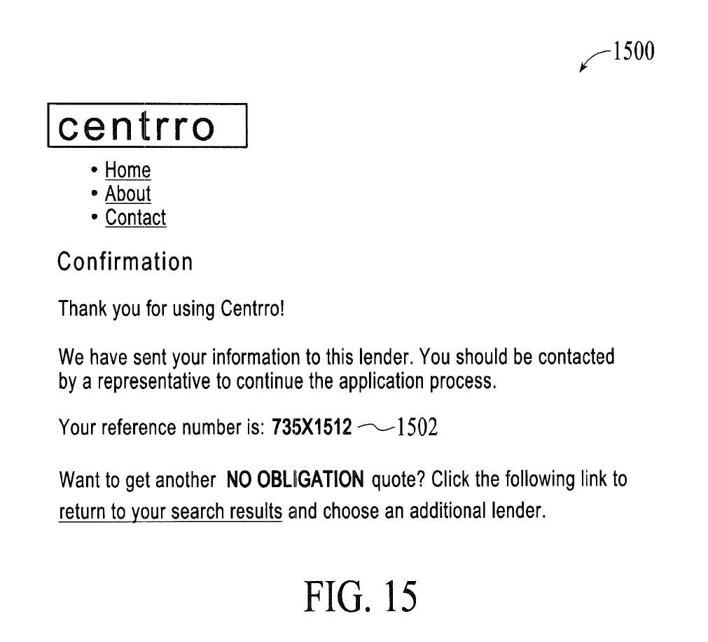

If the user provisionally qualifies for the loan, the process provides displays an application page to the user. FIG. 14 illustrates an example of a loan application web page for this embodiment. The application web page includes several data entry areas 1402 for the input of various items of identification information for the user. These include name, address, and social security information. The online loan application process 112 then uses the user's personal information, including the social security number to obtain the actual credit score for the user. In one embodiment, the process queries one or more credit bureaus to obtain the credit score. Once the credit score or other relevant credit report information has been obtained, the process forwards the information to the lender or originator of the selected loan product. FIG. 15 illustrates an example of a confirmation page for a loan product under this embodiment. This page 1500 alerts the user that the information has been forwarded to the lender, and it provides a reference number 1502 for the application.

In one embodiment, the online loan application process also provides a user feedback mechanism, such as a forum, whereby users of the process can rate the lenders and/or loan products. The process provides a rating system that allows user to enter a numeric, or similar rating, or a descriptive evaluation of the lenders and products accessed through the system.

In one embodiment, the online loan application process may be implemented as a background process executed by a web server when a user accesses a web page served by a server that provides access to products or services that involve some aspect of financing. In this embodiment, the user may not be applying for a loan through the web site itself, such as shown in FIG. 5, but instead may be applying to purchase some other good or service. The good or service may require some element of financing, in which case the web server process for the web site invokes an application that performs the credit pull for the user as a background process, as the user is completing the application or purchase order for the offered good or services. Such a system may be implemented for a variety of applications, such as online universities, or other similar applications in which a user provides personal information online to purchase a relatively expensive item. In this case, the service provider uses the personal information to access the online credit application process 112 to determine the user's credit worthiness with respect to any financing that might be available to help finance the purchase.

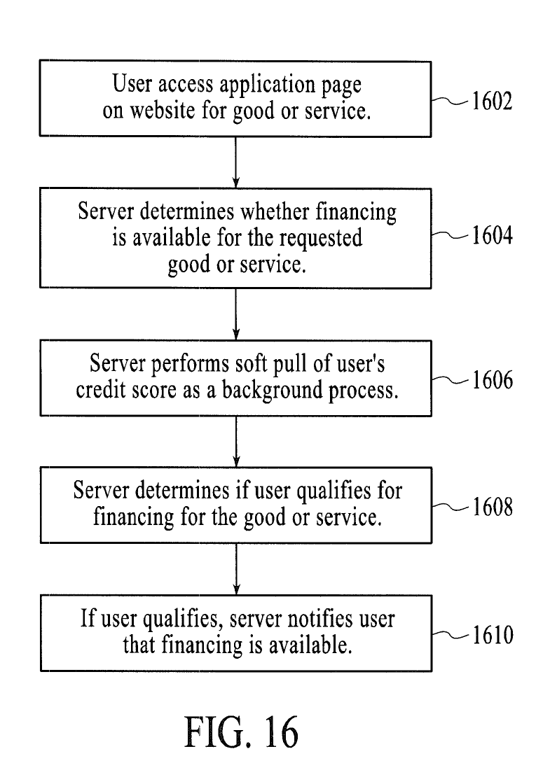

FIG. 16 is a flowchart that illustrates a method of notifying a user of available financing options as a background task through an online form server, under an embodiment. As shown in FIG. 16, the user access an online form that may comprise an application page or purchase page for a particular good or service, block 1602. Examples described herein may reference an online university program, but other applications are also possible. In this step, for example, if a user may be applying for an online degree and will input his or her name, address, and other identifying information, such as social security number. This initiates the application process and also provides a minimum amount of information that the system can use to invoke the online credit application process 112.

Based on the good or service that is requested by the user, the server determines whether or not financing or loans are available to pay for at least part of the purchase price of the requested good or service, block 1604. If such financing is available, the server invokes the online credit application process 112 to perform a soft-pull of the user's credit score, block 1606. In an embodiment, this is performed by the server as background process that is executed as the user is completing the form for the good or service on the website serving the online form. In an embodiment, the online form server transmits to the online credit application process server 104 the required information, such as user name, address, and partial social security number. The online credit application process 112 then performs a soft-pull of the user's credit, as described above. The credit score returned by the credit application process 112 may be the user's FICO (Fair Isaac Corporation) score, or it may be a credit grade or credit identifier that indicates the credit-worthiness of the user through a measure separate from the actual FICO score.

The online form server process then determines if the user qualifies for financing for the requested good or service based on the returned credit score or credit measure for the user, block 1608. If the user qualifies, the server notifies the user that such financing is available, block 1610. The financial package available through the online form by the provider of the good or service may be a loan available from a separate loan provider or financial institution (e.g., bank, lender, grant provider, etc.), or it may be a financial package provided by the provider itself. The provider may elect to provide the financial package to the user directly through the website or online form, or it may elect to provide adequate links or contact information to the user so that that user can apply for the financing separately. In this case, the server process may provide the appropriate command icons or information to the user through the GUI of the online form.

Embodiments of the online loan application system described herein may be applied to various types of loan or credit products, such as residential, consumer or mortgage loans, credit cards, rotating lines of credit, and the like. In general, the application for any such loan or credit product requires the lender to obtain a copy the user's credit report. Such a credit report is typically maintained and made available by credit bureaus such as Equifax™, Experian™, or Transunion™. When a user requests a credit report, the user's credit rating may be adversely affected. In general, multiple credit report pulls results in the lowering of a user's credit rating. Embodiments of the present invention allow a user to apply for loan or credit products in a manner that does not directly result in his or her credit report being pulled, and thus does not adversely affect the credit rating. This is accomplished by the user providing the system with his or her credit score directly, or having the credit bureau itself perform the match between the user credit score and the desired loan product and not sending the credit score out to the lender. Such “below the line” credit reporting protects the integrity of the user's personal information and does not adversely affect the credit score, because the credit report is not transferred out, thus the system administrator or any other third party does not take possession of the credit report.

Embodiments of the credit checking process described herein may also be used for applications beyond loan processing, such as credit-based targeted advertising (display, performance, outbound offers, and so on), and the like.

Aspects of the system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media). Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the online loan and credit application system is not intended to be exhaustive or to limit the embodiments to the precise form or instructions disclosed. While specific embodiments of, and examples for, the online loan and credit application system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the online loan application system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the online loan application system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method comprising:
on a first server computer coupled to a client computer operated by a user, receiving a request by the user to purchase an item through an online application form, the request including identification information of the user;
determining whether financing is available for at least part of the purchase request;
transmitting the identification information to a second server, wherein the second server is configured to obtain a measure of the user's qualification to obtain the financing through a below-the-line credit check from a credit bureau;
receiving from the second server the measure of the user's qualification and comparing it to the requirements of the financing; and
notifying the user that the financing is available if the measure of the user's qualification satisfies the requirements of the financing.

2. The method of claim 1 wherein the identification information comprises the user name, address and at least a portion of the user's social security number.

3. The method of claim 2 wherein the measure of the user's qualification comprises a credit score provided by a credit rating authority.

4. The method of claim 2 wherein the request includes financial information comprising a credit history information of the user, and wherein the method further comprises:
evaluating the financial information;
evaluating the selected loan qualification requirements as defined by a provider of the selected loan;
making a provisional qualification determination based on the evaluation of the financial information and the selected loan qualification requirements; and
transmitting the provisional qualification determination to the user.

5. The method of claim 4 further comprising, if the qualification determination is negative:
transmitting a message to the user stating that the user is not qualified for the selected loan; and
displaying a list of other possible financing options available to the user.

6. The method of claim 3 wherein the measure of the user's qualification comprises a descriptive characterization selected from a range of possible characterizations.

7. A system including a first server computer coupled to a client computer operated by a user, the system comprising:
means for receiving a request by the user to purchase an item through an online application form, the request including identification information of the user;
means for determining whether financing is available for at least part of the purchase request;
means for transmitting the identification information to a second server, wherein the second server is configured to obtain a measure of the user's qualification to obtain the financing through a below-the-line credit check from a credit bureau;
means for receiving from the second server the measure of the user's qualification and comparing it to the requirements of the financing; and
means for notifying the user that the financing is available if the measure of the user's qualification satisfies the requirements of the financing.

8. The system of claim 7 wherein the identification information comprises the user name, address and at least a portion of the user's social security number.

9. The system of claim 7 wherein the measure of the user's qualification comprises a credit score provided by a credit rating authority.

10. The system of claim 9 wherein the request includes financial information comprising a credit history information of the user, and wherein the system further comprises:
means for evaluating the financial information;
means for evaluating the selected loan qualification requirements as defined by a provider of the selected loan;
means for making a provisional qualification determination based on the evaluation of the financial information and the selected loan qualification requirements; and
means for transmitting the provisional qualification determination to the user.

11. The system of claim 10 further comprising, if the qualification determination is negative:
means for transmitting a message to the user stating that the user is not qualified for the selected loan; and
means for displaying a list of other possible financing options available to the user.

12. The system of claim 8 wherein the measure of the user's qualification comprises a descriptive characterization selected from a range of possible characterizations.
